(19) United States
(12) Patent Application Publication
(10) Pub. No.: US 2011/0274411 A1
(43) Pub. Date: Nov. 10, 2011

(54) INFORMATION PROCESSING DEVICE AND METHOD, AND PROGRAM

(76) Inventors: Takao OKUDA, Tokyo (JP); Mototsugu Abe, Kanagawa (JP)

(21) Appl. No.: 13/081,908

(22) Filed: Apr. 7, 2011

(30) Foreign Application Priority Data
Apr. 26, 2010 (JP) P2010-100927

(51) Int. Cl. H04N 5/93

(52) U.S. Cl. 386/278; 386/E05.003

(57) ABSTRACT

An information processing device for analyzing motion and color of an image of a program and detecting shot sound and cheering of golf includes an extraction unit that extracts a notable interval which is a notable time interval of the program based on the motion of the image, a computation unit that computes a play scene level indicating a degree to which the notable interval is a play scene of the golf based on the motion, color and shot sound of the notable interval extracted by the extraction unit, and a determination unit that determines whether or not the notable interval is a play scene of the golf based on the play scene level computed by the computation unit.

### BACKGROUND OF THE INVENTION

1. Field of the Invention

The present invention relates to an information processing device and method and a program and, more particularly, to an information processing device and method for more suitably reproducing a play scene of golf in a digest, and a program.

2. Description of the Related Art

Recently, various techniques of reproducing a sports program such as baseball or soccer in a digest have been proposed.

For example, a desired image interval is specified based on a pattern of camerawork of an image (for example, see Japanese Unexamined Patent Application Publication No. 2008-5204).

In addition, a highlight scene is generated by analyzing cheers of spectators from their audios and extracting a climax scene.

### SUMMARY OF THE INVENTION

However, if a sports program is a golf relay program, since it is fundamentally silent during the play of the golf, the play scene of the golf may not be extracted as a highlight scene with certainty by the configuration for extracting the climax scene.

In the method of Japanese Unexamined Patent Application Publication No. 2008-5204, since only image information is used without using audio information, there is a possibility that a desired image interval may not be specified with high precision depending on the image.

It is desirable to more suitably reproduce a play scene of golf in a digest.

According to an embodiment of the present invention, there is provided an information processing device for analyzing the motion and color of an image of a program and detecting the hitting sounds and cheering in a golf game from audio of the program, including: an extraction means for extracting a notable interval which is a notable time interval of the program based on the motion of the image; a computation means for computing a play scene level indicating a degree to which the notable interval is a play scene of the golf based on the motion, color and shot sound of the notable interval extracted by the extraction means; and a determination means for determining whether or not the notable interval is a play scene of the golf based on the play scene level computed by the computation means.

The extraction means may extract, as a start point and an end point of the notable interval, the notable interval using a stop interval in which a motion amount of the image is less than a predetermined amount in the program.

The computation means may compute the play scene level of the notable interval based on the shot sound of the start point of the notable interval.

The computation means may compute the play scene level of the notable interval based on a maximum value of the motion of the notable interval.

The computation means may compute the play scene level of the notable interval based on a blueness level and a whiteness level of the color detected in the notable interval.

The computation means may compute the play scene level of the notable interval based on a change of a vertical direction of the motion of the notable interval.

The computation means may compute the play scene level of the notable interval based on small motion of the start point and the end point of the notable interval.

The determination means may weight the cheering detected in the notable interval to the play scene level of the notable interval computed by the computation means and determine whether or not the notable interval is the golf play scene.

The information processing device may further include a reproduction control means for controlling reproduction of only the play scene of the program based on scene information indicating the notable interval regarded as the play scene as the determination result of the determination means.

According to another embodiment of the present invention, there is provided an information processing method of an information processing device which analyzes motion and color of an image of a program and detects a golf shot sound and cheering from audio of the program and includes an extraction means for extracting a notable interval which is a notable time interval of the program based on the motion of the image, a computation means for computing a play scene level indicating a degree to which the notable interval is a play scene of the golf based on the motion, color and shot sound of the notable interval extracted by the extraction means, and a determination means for determining whether or not the notable interval is a play scene of the golf based on the play scene level computed by the computation means, the information processing method including the steps of: extracting the notable interval which is the notable time interval of the program based on the motion of the image, by the extraction means; computing the play scene level indicating a degree to which the notable interval is the play scene of the golf based on the motion, color and shot sound of the notable interval extracted by the step of extracting, by the computation means; and determining whether or not the notable interval is the play scene of the golf based on the play scene level computed by the step of computing, by the determination means.

According to another embodiment of the present invention, there is provided a program for executing, on a computer, a process of analyzing motion and color of an image of a program and detecting a golf shot sound and cheering from audio of the program, the process including the steps of: extracting a notable interval which is a notable time interval of the program based on the motion of the image; computing a play scene level indicating a degree to which the notable interval is a play scene of the golf based on the motion, color and shot sound of the notable interval extracted by the extracting step; and determining whether or not the notable interval is a play scene of the golf based on the play scene level computed by the computing step.

According to the embodiments of the present invention, a notable interval which is a notable time interval of a program is extracted based on the motion of the image, a play scene level indicating a degree to which the notable interval is a play scene of the golf is computed based on the motion, color and shot sound of the extracted notable interval, and a determination as to whether or not the notable interval is a play scene of the golf is made based on the computed play scene level.

According to the embodiments of the present invention, it is possible to more suitably reproduce the play scene of the golf in a digest.

### BRIEF DESCRIPTION OF THE DRAWINGS

FIG. 1 is a block diagram showing a functional configuration example of an information processing device according to an embodiment of the present invention;

FIG. 2 is a diagram illustrating detection of a shot sound;

FIG. 3 is a diagram illustrating detection of a shot sound;

FIG. 4 is a block diagram showing a functional configuration example of a play scene extraction unit;

FIG. 5 is a flowchart illustrating a play scene extraction process;

FIG. 6 is a diagram illustrating a stop interval;

FIG. 7 is a diagram illustrating an example of computing a play scene level;

FIG. 8 is a block diagram showing a functional configuration example of a reproduction device;

FIG. 9 is a flowchart illustrating a play scene reproduction process;

FIG. 10 is a block diagram showing a functional configuration example of a recording/reproduction device according to an embodiment of the present invention; and

FIG. 11 is a block diagram showing a configuration example of hardware of a computer.

### DESCRIPTION OF THE PREFERRED EMBODIMENTS

Hereinafter, the embodiments of the present invention will be described with reference to the accompanying drawings. The description will be given in the following order.

1. First Embodiment (Configuration for Extracting Play Scene of Golf Relay Program)

2. Second Embodiment (Configuration for Extracting and Reproducing Play Scene of Golf Relay Program)

### 1. First Embodiment

### Functional Configuration Example of Play Scene Detection Device

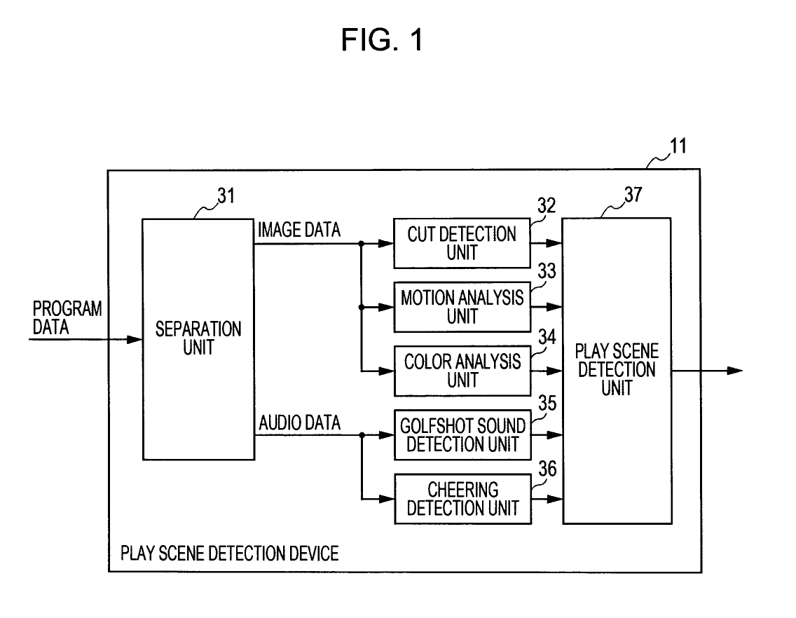

FIG. 1 shows a functional configuration example of a play scene detection device as an information processing device according to an embodiment of the present invention.

The play scene detection device 11 of FIG. 1 separates program data of a golf relay program as an input television program into image data and audio data and analyzes or detects a plurality of feature amounts from the data. The play scene detection device 11 detects a play scene from the program data of the input golf relay program based on the analyzed or detected feature amounts.

The play scene detection device 11 of FIG. 1 includes a separation unit 31, a cut detection unit 32, a motion analysis unit 33, a color analysis unit 34, a golf shot sound detection unit 35, a cheering detection unit 36 and a play scene extraction unit 37.

The separation unit 31 separates the program data of the input golf relay program (hereinafter, simply referred to as a golf program) into image data and audio data. The separated image data (hereinafter, simply referred to as an image) is supplied to the cut detection unit 32, the motion analysis unit 33 and the color analysis unit 34 and the audio data (hereinafter, simply referred to as audio) is supplied to the golf shot sound detection unit 35 and the cheering detection unit 36.

The cut detection unit 32 detects an image switching point (cut change) in the image from the separation unit 31 and supplies a time of the cut change to the play scene extraction unit 37 as cut information. For example, the cut detection unit 32 detects the cut change by the method disclosed in Japanese Unexamined Patent Application Publication No. 2008-85540.

That is, first, the cut detection unit 32 calculates a degree of similarity between two frames of frames 1 to 3 consecutive in time in the image from the separation unit 31, respectively. Next, the cut detection unit 32 generates a synthetic image obtained by synthesizing reduced images of the frames 1 and 3 and calculates a degree of similarity thereof with a reduced image of the frame 2. The cut detection unit 32 determines whether a cut change is present between the frame 1 and the frame 3 based on the degree of similarity between two frames of the frames 1 to 3 and the degree of similarity between the synthetic image and the reduced image of the frame 2.

The motion analysis unit 33 analyzes motion of the image from the separation unit 31 and supplies the motion amount of each frame and the time of the frame to the play scene extraction unit 37 as motion information. For example, the motion analysis unit 33 performs a template matching process so as to analyze the motion of the image.

That is, the motion analysis unit 33 generates a reduced image from an image of a predetermined frame from the separation unit 31 and sets a central region thereof as a template. The motion analysis unit 33 performs the template matching process using the inside of the image positioned a few frames in front as a search range using the set template and calculates a motion amount using a position (pixel position), in which an evaluation function expressed by Equation 1 is minimized, as a movement position.

$${\sum }_{i = 0}^{Ht - 1} {\sum }_{j = 0}^{Wt - 1} {( {Y}_{c} ( i , j ) - {Y}_{p} ( i , j ) )}^{2} \qquad ( 1 )$$

In Equation 1, Ht and Wt respectively denote the height and the width of the template, that is, the number of pixels in the height direction and the width direction of the template, and i and j denote pixel positions of the template. In Equation 1, Y_{c} denotes the luminance value of the pixel of the image of a current frame and Yₚ denotes the luminance value of the pixel of the image positioned a few frames in front.

The color analysis unit 34 analyzes the color of each pixel within the image from the separation unit 31 for each frame, obtains a sky degree indicating the degree to which sky is included in the image from the separation unit 31, and supplies the obtained sky degree and the time of the frame to the play scene extraction unit 37 as color information. The sky degree is expressed by a sum of a blueness level Pb indicating the degree of blueness of the image and a whiteness level Pw indicating the degree of whiteness of the image. The blueness level Pb and the whiteness level Pw are expressed by Equations 2 and 3.

$$\begin{matrix}BLUENESS LEVEL Pb = {\sum }_{i = 1}^{H} {\sum }_{j = 1}^{W} min ( max ( {B}_{ij} - {G}_{ij} , 0 ) , max ( {B}_{ij} - {R}_{ij} , 0 ) ) & ( 2 ) \\ WHITENESS LEVEL Pw = {\sum }_{i = 1}^{H} {\sum }_{j = 1}^{W} {d}_{rgb} \times {Y}_{ij} & ( 3 )\end{matrix}$$

In Equations 2 and 3, min( ) and max( ) respectively denote functions for outputting a minimum value and a maximum value within respective parentheses, and Rᵢⱼ, Gᵢⱼ, Bᵢⱼ and Yᵢⱼ respectively denote the color component values of R, G and B and the luminance value of each pixel. In addition, d_{rgb} denotes a distance between each pixel and a straight line r=g=b in a color space. In addition, H and W respectively denote the height and the width of the image, that is, the number of pixels of the height direction and the width direction and i and j respectively denote the pixel positions of the image.

The golf shot sound detection unit 35 detects a sound (hereinafter, referred to as a shot sound) at the instant that a golf player strikes a golf ball using a club from the audio from the separation unit 31 and supplies the time thereof and a golf shot sound level indicating the shot sound to the play scene extraction unit 37 as golf shot sound information.

In general, in golf, there is relative silence before and after the instant that the player strikes the ball using the club such that sound is not substantially detected, and only the shot sound is detected as very loud sound.

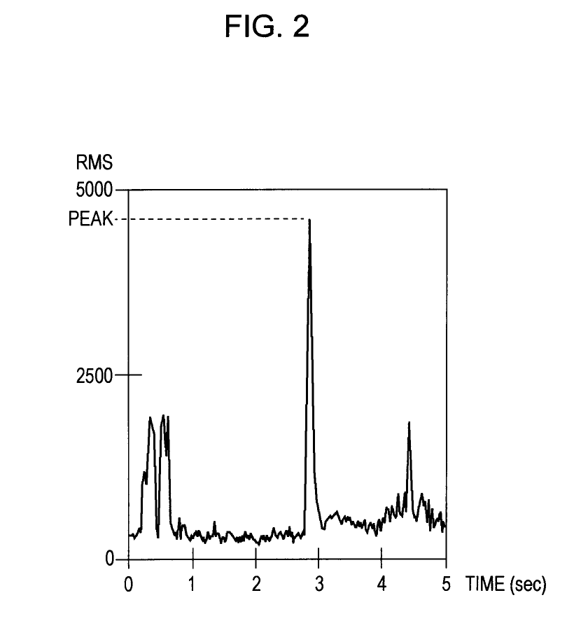

The golf shot sound detection unit 35 computes, for example, a Root Mean Square (RMS) value of an amplitude of the audio (audio data) shown in FIG. 2. In FIG. 2, a horizontal axis denotes a time (the unit thereof is seconds) and a vertical axis denotes an RMS value. If the peak value Peak of the RMS value is greater than a threshold Trms and the peak value Peak is significantly greater than values before and after the peak value Peak, the golf shot sound detection unit 35 detects the peak value Peak as the shot sound. The golf shot sound detection unit 35 sets the shot sound level to 1 if the detected shot sound is greater than another threshold Tsh and sets the shot sound level to 0 if the detected shot sound is less than another threshold Tsh. A difference Peak-Tsh between the peak value Peak and the threshold Tsh may be set to the shot sound level.

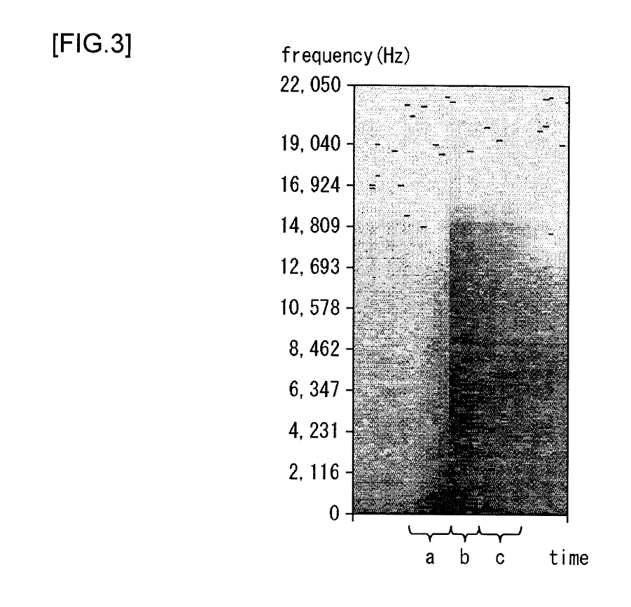

In order to further increase the precision of the detection of the shot sound, frequency analysis may be performed with respect to the audio (audio data) so as to obtain a spectrogram shown in FIG. 3. FIG. 3 shows the spectrogram of a typical shot sound, in which the horizontal axis denotes the time, the vertical axis denotes the frequency, and the density of the color of each point on a coordinate indicates the level of the amplitude of the audio data. In the spectrogram of FIG. 3, wind noise by swing just before impact appears at a time a, the sound (shot sound) of the instant of impact appears at a time b, and resonance sound of the club after impact appears at a time c.

That is, in this case, the golf shot sound detection unit 35 stores the spectrogram of FIG. 3 as a reference spectrogram in advance and performs frequency analysis with respect to the audio data so as to obtain a spectrogram. In addition, the golf shot sound detection unit 35 compares the obtained spectrogram and the reference spectrogram so as to set intervals having features appearing at the times a to c of FIG. 3 as the interval including the shot sound and computes the RMS value of the amplitude of the audio data shown in FIG. 2 in the intervals.

Although, in the above description, the interval including the shot sound is specified to some extent by the spectrogram such that the RMS value of the amplitude of the audio data is computed, this may be combined with, for example, a statistical modeling method such as a Gaussian Mixture Model (GMM) or a Support Vector Machine (SVM) or a method of computing the RMS value of the amplitude of the audio data.

Returning to FIG. 1, the cheering detection unit 36 detects the cheers of spectators in the audio from the separation unit 31 and supplies the time thereof and the cheering level indicating the cheers to the play scene extraction unit 37 as cheering information. For example, the cheering detection unit 36 detects cheering by the method disclosed in Japanese Patent No. 3891111.

That is, the cheering detection unit 36 extracts a sound quality feature amount of sound quality from the audio (audio data) from the separation unit 31 and quantifies unique sound quality when spectators cheer, that is, unique sound quality of a climax part, thereby detecting cheering.

The play scene extraction unit 37 executes a play scene extraction process based on cut information from the cut detection unit 32, motion information from the motion analysis unit 33, color information from the color analysis unit 34, shot sound information from the golf shot sound detection unit 35 and cheering information from the cheering detection unit 36 and extracts a play scene from the golf relay program.

### Functional Configuration Example of Play Scene Extraction Unit

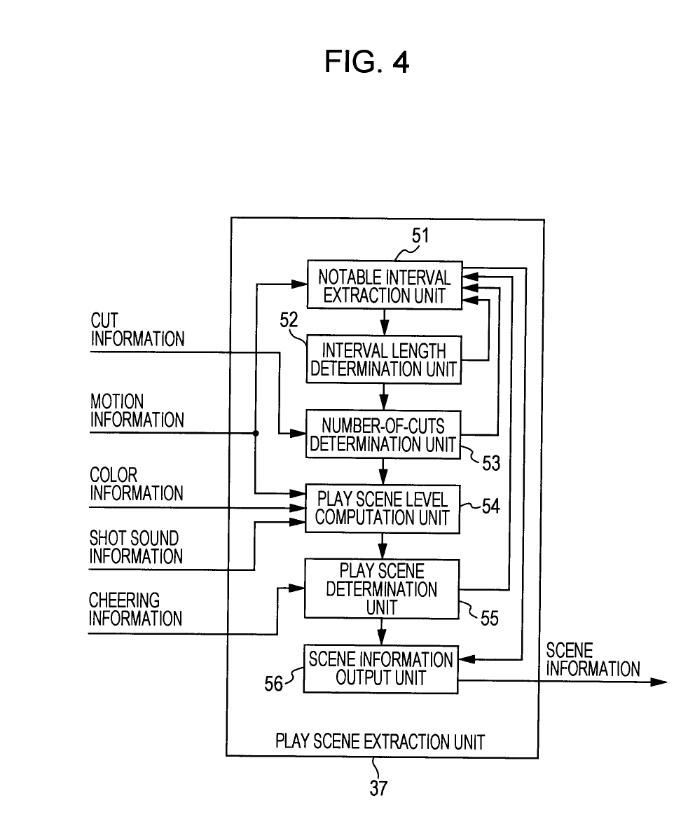

Now, the functional configuration example of the play scene extraction unit 37 will be described with reference to FIG. 4.

The play scene extraction unit 37 includes a notable interval extraction unit 51, an interval length determination unit 52, a number-of-cuts determination unit 53, a play scene level computation unit 54, a play scene determination unit 55 and a scene information output unit 56.

The notable interval extraction unit 51 extracts a notable interval which is a notable time interval of the golf program based on the motion information from the motion analysis unit 33 and supplies notable interval information indicating the notable interval to the interval length determination unit 52.

The interval length determination unit 52 determines whether or not the time length of the notable interval (hereinafter, referred to as an interval length) is shorter than a threshold based on the notable interval information from the notable interval extraction unit 51 and supplies information obtained by the determination result to the notable interval extraction unit 51 or the number-of-cuts determination unit 53.

When the information obtained by the determination result is supplied from the interval length determination unit 52, the number-of-cuts determination unit 53 determines whether or not the number of cuts in the notable interval is less than a threshold based on the cut information from the cut detection unit 32. The number-of-cuts determination unit 53 supplies information obtained by the determination result to the notable interval extraction unit 51 or the play scene level computation unit 54.

When the information obtained by the determination result is supplied from the number-of-cuts determination unit 53, the play scene level computation unit 54 computes a play scene level indicating a degree to which the notable interval (the scene of the notable interval) is the play scene of the golf based on the motion information from the motion analysis unit 33, the color information from the color analysis unit 34 and the shot sound information from the golf shot sound detection unit 35. The play scene level computation unit 54 supplies the computed play scene level to the play scene determination unit 55.

The play scene determination unit 55 determines whether or not the notable interval is a play scene based on the play scene level from the play scene level computation unit 54. In addition, the play scene determination unit 55 weights the cheering information from the cheering detection unit 36 to the play scene level from the play scene level computation unit 54 upon determination. The play scene determination unit 55 supplies information obtained from the determination result to the notable interval extraction unit 51 or the scene information output unit 56.

The scene information output unit 56 outputs scene information indicating the notable interval regarded as the play scene to a recording medium or a reproduction device (not shown) based on the information obtained from the determination result from the play scene determination unit 55.

### Play Scene Extraction Process

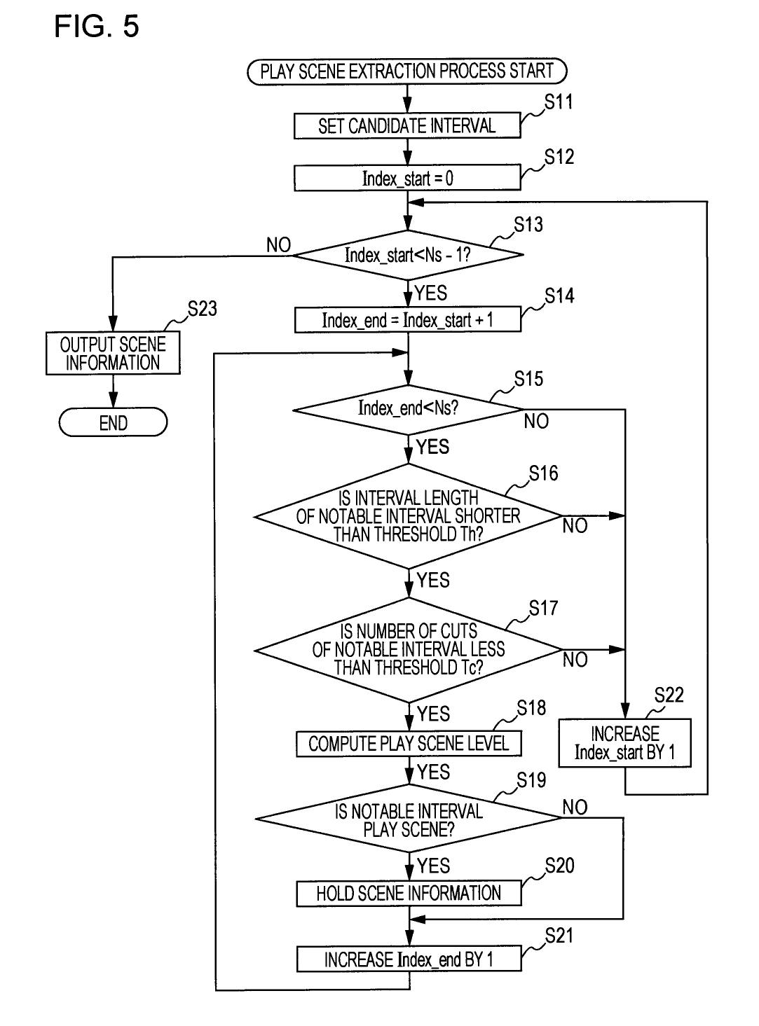

Next, the play scene extraction process of the play scene extraction unit 37 will be described with reference to the flowchart of FIG. 5.

The play scene extraction process begins by inputting the golf program to the play scene detection device 11, separating the golf program into the image and audio by the separation unit 31, and supplying the respective information from the cut detection unit 32 to the cheering detection unit 36 to the play scene extraction unit 37.

Hereinafter, the respective information from the cut detection unit 32 to the cheering detection unit 36 is appropriately referred to as feature information.

In step S11, the notable interval extraction unit 51 sets candidate intervals which are the candidates of a start point and an end point of the notable interval of the golf program based on the motion information from the motion analysis unit 33.

Specifically, first, the notable interval extraction unit 51 detects a stop interval in which the motion amount of the image is less than a predetermined amount in the golf program based on the motion information from the motion analysis unit 33.

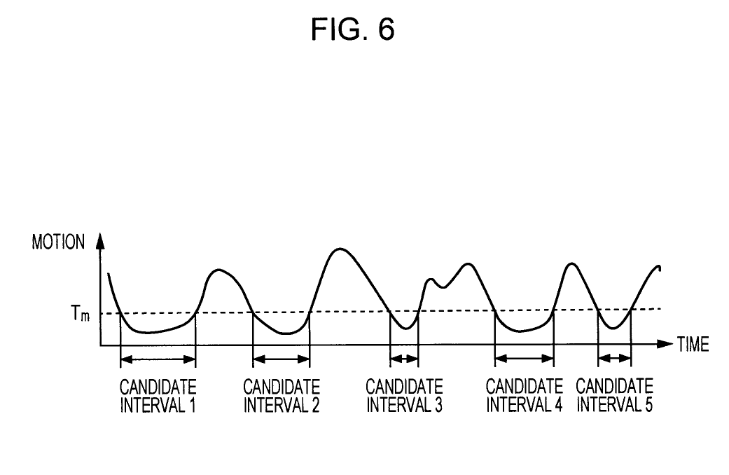

Now, the stop interval detected by the notable interval extraction unit 51 will be described with reference to FIG. 6.

FIG. 6 shows a motion amount change in a predetermined time interval of the golf program. In FIG. 6, a horizontal axis denotes a time and a vertical axis denotes motion (motion amount).

If the motion information indicating the motion amount shown in FIG. 6 is supplied from the motion analysis unit 33, the notable interval extraction unit 51 sets an interval in which the motion amount is less than a threshold Tm as the stop interval.

In general, the play scene of the golf may include three scenes as follows.

Scene 1: scene in which a player strikes a ball

Scene 2: scene in which the struck ball flies

Scene 3: scene in which the ball falls and comes to a stop

In Scene 1, a television camera photographs the instant that the player strikes the ball at a fixed position. In addition, a shot sound is generated at the instant that the player strikes the ball.

In Scene 2, the television camera tracks and films the flying ball. At this time, the background of the filmed ball may be the sky.

In Scene 3, the television camera photographs the ball falling to the fairway, rolling and finally stopping.

In the play scenes of the golf including Scene 1 to 3, there is no substantial motion amount of the image at the start (Scene 1) and the end (Scene 3).

Therefore, the notable interval extraction unit 51 sets the stop intervals in which the motion amount is less than the threshold Tm as the candidate intervals which are the candidates of the start point and the end time of the notable interval. In FIG. 6, 5 stop intervals are set as candidate intervals 1 to 5. At this time, the notable interval extraction unit 51 generates indexes 0 to 4 respectively corresponding to the candidate intervals 1 to 5.

In step S12, the notable interval extraction unit 51 sets an index (hereinafter, referred to as a start index) Index_start of the candidate interval which becomes a start point of the notable interval to Index_start=0. That is, in the example of FIG. 6, the candidate interval 1 is set as the start point of the notable interval.

In step S13, the notable interval extraction unit 51 determines whether or not the start index Index_start is less than a value Ns−1 obtained by subtracting 1 from the total number Ns (in the example of FIG. 6, Ns=5) of candidate intervals.

In step S13, if it is determined that the start index Index_start is less than Ns−1, the process proceeds to step S14 and the notable interval extraction unit 51 sets an index (hereinafter, referred to as an end index) Index_end of the candidate interval which becomes an end point of the notable interval to Index_start+1. In the case of Index_start=0, since Index_end=1, in the example of FIG. 6, the candidate interval 2 is set as the end point of the notable interval.

That is, the notable interval extraction unit 51 sets the notable interval, of which the start point is the candidate interval 1 and the end point is the candidate interval 2. More specifically, the notable interval extraction unit 51 sets the notable interval in which the start time of the candidate interval 1 is set as the start point and the end time of the candidate interval 2 is set as the end point. Hereinafter, the notable interval in which the start point is the candidate interval 1 and the end point is the candidate interval 2 is set to the notable intervals 1 to 2.

That is, in the example of FIG. 6, as the notable interval, in addition to the notable intervals 1 to 2, notable intervals 1 to 3, notable intervals 1 to 4, notable intervals 1 to 5, notable intervals 2 to 3, notable intervals 2 to 4, notable intervals 2 to 5, notable intervals 3 to 4, notable intervals 3 to 5 and notable intervals 4 to 5 are sequentially set by the below-described process.

In step S15, the notable interval extraction unit 51 determines whether or not the end index Index_end is less than the total number Ns of candidate intervals.

If it is determined that the end index Index_end is less than the total number Ns of candidate intervals in step S15, the notable interval extraction unit 51 supplies information indicating the start point and the end point of the notable interval (specifically, the start time of the candidate interval which becomes the start point and the end time of the candidate interval which becomes the end point) to the interval length determination unit 52 as notable interval information and the process proceeds to step S16.

In step S16, the interval length determination unit 52 determines whether or not the interval length T of the notable interval is shorter than a threshold Th based on the notable interval information from the notable interval extraction unit 51. The threshold Th is set based on an average time consumed when the player strikes the ball and the struck ball flies, falls and stops, and may be set to, for example, 30 seconds or the like.

In step S16, if it is determined that the interval length T of the notable interval is shorter than the threshold Th, the interval length determination unit 52 supplies the notable interval information to the number-of-cuts determination unit 53 and the process proceeds to step S17.

In step S17, when the notable interval information is supplied from the interval length determination unit 52, the number-of-cuts determination unit 53 obtains the number of cuts included in the notable interval expressed by the notable interval information based on the time of the cut change as the cut information from the cut detection unit 32. The number-of-cuts determination unit 53 determines whether or not the number of cuts of the notable interval is less than a threshold Tc. The threshold Tc is set based on an average number of cuts when the player strikes the ball and the struck ball flies, falls and stops, and may be set to, for example, 4 or the like.

In step S17, if it is determined that the number of cuts of the notable interval is less than the threshold Tc, the number-of-cuts determination unit 53 supplies the notable interval information to the play scene level computation unit 54 and the process proceeds to step S18.

In step S18, when the notable interval information is supplied from the number-of-cuts determination unit 53, the play scene level computation unit 54 computes the play scene level of the notable interval expressed by the notable interval information based on the feature information from the motion analysis unit 33, the color analysis unit 34 and the golf shot sound detection unit 35.

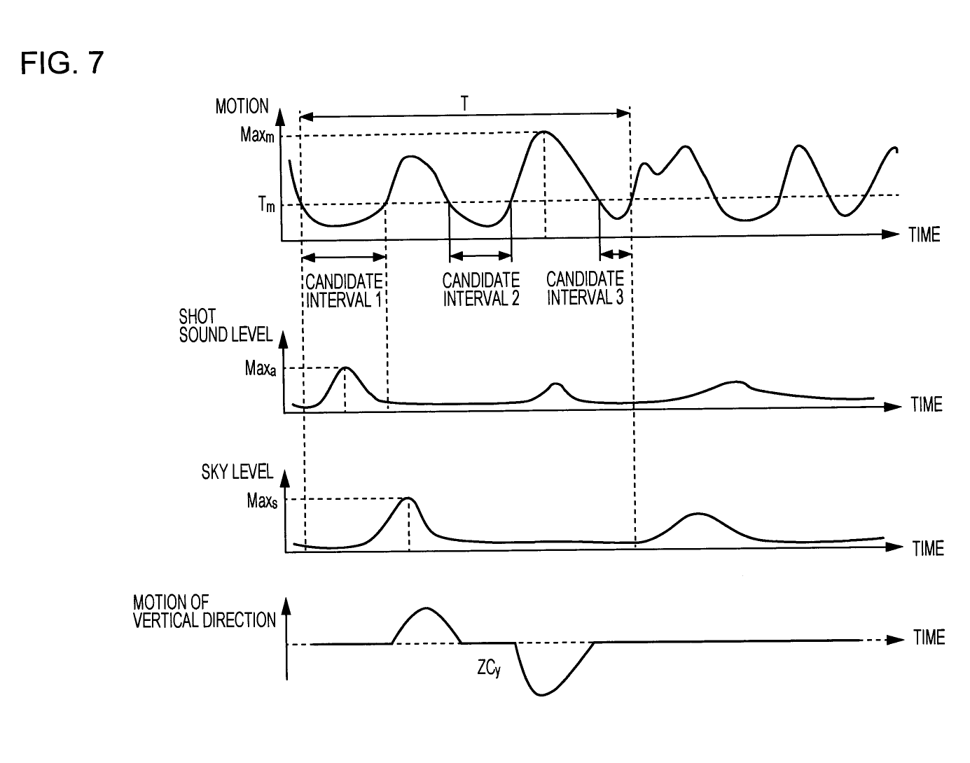

Now, the example of the computation of the play scene level by the play scene level computation unit 54 will be described with reference to FIG. 7.

FIG. 7 shows the feature information corresponding to the notable intervals 1 to 3 when the candidate intervals 1 to 3 shown in FIG. 6 are extracted as the notable interval.

A first graph from the top of FIG. 7 shows a motion amount change of the notable intervals 1 to 3 based on the motion information from the motion analysis unit 33 and is equal to FIG. 6. In addition, in FIG. 7, a time from the start time of the candidate interval 1 to the end time of the candidate interval 3 is denoted by the interval length T.

A second graph from the top of FIG. 7 shows a shot sound change in the notable interval based on the shot sound information from the golf shot sound detection unit 35, in which the horizontal axis denotes the time and the vertical axis denotes the shot sound level.

A third graph from the top of FIG. 7 shows a sky level change in the notable interval based on the color information from the color analysis unit 34, in which the horizontal axis denotes the time and the vertical axis denotes the sky level.

A fourth graph from the top of FIG. 7 shows motion (motion amount) of the vertical direction in the notable interval based on the motion information from the motion analysis unit 33, in which the horizontal axis denotes the time and the vertical axis denotes the motion of the vertical direction. The motion of the vertical direction has a positive value when the television camera is panned in an upward direction, that is, relative to when the direction of the motion within the image is a downward direction and has a negative value when the television camera is panned in a downward direction, that is, relative to when the direction of the motion within the image is an upward direction.

From such feature information, the play scene level computation unit 54 decides play scene elements which become the elements of the play scene level corresponding to the feature information in the notable interval. Next, the examples of the play scene elements in the notable interval will be described.

Play scene element x₁: maximum value of motion amount

Play scene element x₂: maximum value of shot sound level in the start point (stop interval)

Play scene element x₃: maximum value of sky level

Play scene element x₄: number of zero crossings of motion of vertical direction

Play scene element x₅: degree of stopping in each stop interval

Play scene element x₆: time of notable interval

In the example of FIG. 7, the play scene element x₁ is decided as the motion amount Maxₘ of the candidate intervals 2 to 3, the play scene element x₂ is decided as the shot sound level Maxₐ of the candidate interval 1, the play scene element x₃ is decided as the sky level Maxₛ of the candidate intervals 1 to 2, and the play scene element x₄ is decided as the number ZC_{y} of zero crossings of the candidate interval 2. In addition, the play scene element x₅ is, for example, decided by small motion of the start point and end point (candidate intervals 1 and 3) as the average value of the motion amount and the play scene element x₆ is decided as the interval length T of the notable interval.

The play scene level computation unit 54 computes the play scene level y expressed by, for example, Equation 4, based on the decided play scene element.

$$y = {\sum }_{i = 0}^{M - 1} {w}_{i} {x}_{i} + b \qquad ( 4 )$$

Here, if the total number of play scene elements is M, in Equation 4, i has a value in a range of 0≦i≦M−1. In addition, wi denotes a weight coefficient and b denotes a predetermined bias value. Various statistical discrimination methods may be used to decide the weight coefficient wi and the bias value b. For example, the play scene levels of a plurality of scenes may be subjectively evaluated in advance, a weighting approximating a straight-line according to by multiple linear regression analysis using learning data having a set of a feature vector and a preferable play scene level (for example, 1 in the case where it is a play scene, −1 in the case where it is not a play scene, etc.) may be obtained, and the weight coefficient wi and the bias value b may be decided. A statistical discrimination method such as a neural network such as perceptron or SVM may be used.

In this way, the play scene level computation unit 54 computes the play scene level y and supplies the play scene level y to the play scene determination unit 55 along with the notable interval information.

In step S19, the play scene determination unit 55 determines whether or not the play scene level y from the play scene level computation unit 54 is greater than a predetermined threshold Ty so as to determine whether or not the notable interval expressed by the notable interval information is a play scene.

The play scene determination unit 55 performs determination by weighting the play scene level y according to the maximum value of the notable interval of the cheering level as the cheering information from the cheering detection unit 36 upon determination. That is, as the maximum value of the cheering level of the notable interval is increased, the weight of the play scene level y is increased.

In step S19, if it is determined that the notable interval is a play scene, the play scene determination unit 55 supplies the play scene level y and the notable interval information to the scene information output unit 56. The play scene determination unit 55 supplies the information indicating that it is determined that the notable interval is the play scene to the notable interval extraction unit 51.

In step S20, the scene information output unit 56 obtains the start time and the time length of the play scene based on the notable interval information from the play scene determination unit 55. The scene information output unit 56 associates the play scene level y from the play scene determination unit 55 with the start time and the time length of the play scene as the degree of importance of the play scene. The scene information output unit 56 holds (stores) the start time, the time length and the degree of importance of the play scene as scene information indicating the play scene.

In contrast, in step S19, if it is determined that the notable interval is not a play scene, the play scene determination unit 55 supplies the information indicating that the notable interval is not a play scene to the notable interval extraction unit 51. Thereafter, the process of step S20 is skipped and the process proceeds to step S21.

In step S21, the notable interval extraction unit 51 increases the end index Index_end by 1 according to the information from the play scene determination unit 55 and the process returns to step S15. Thus, for example, in the case of Index_start=0, the notable intervals 1 to 2, the notable intervals 1 to 3, the notable intervals 1 to 4, the notable intervals 1 to 5 and the end point of the notable interval are shifted by 1.

In step S15, if it is determined that the end index Index_end is not less than the total number Ns of candidate intervals, the process proceeds to step S22.

If it is determined that the interval length T of the notable interval is not shorter than the threshold Th in step S16 or if it is determined that the number of cuts of the notable interval is not less than the threshold Tc in step S17, the interval length determination unit 52 or the number-of-cuts determination unit 53 supplies the information indicating the determination content to the notable interval extraction unit 51 and the process proceeds to step S22.

In step S22, the notable interval extraction unit 51 increases the start index Index_start by 1. Thus, the start point of the notable interval is shifted by 1. After step S22, the process returns to step S13 and the processes of steps S13 to S22 are repeated.

In this way, in the example of FIG. 6, the notable interval transitions in the order of the notable intervals 1 to 2, the notable intervals 1 to 3, the notable intervals 1 to 4, the notable intervals 1 to 5, the notable intervals 2 to 3, the notable intervals 2 to 4, the notable intervals 2 to 5, the notable intervals 3 to 4, the notable intervals 3 to 5 and the notable intervals 4 to 5.

If the start index Index_start is not less than Ns−1 in step S13, for example, in the example of FIG. 6, if the start point of the notable interval becomes the candidate interval 5, the notable interval extraction unit 51 supplies the information indicating that the processing of all the notable intervals is completed to the scene information output unit 56 and the process proceeds to step S23.

In step S23, the scene information output unit 56 outputs the held scene information to a recording medium, a reproduction device (not shown), or the like.

At this time, if the play scene (notable scene) indicated by the scene information is completely included in the play scene indicated by other scene information, the scene information is not output but only the other scene information is output. That is, in the example of FIG. 6, if it is determined that the notable intervals 1 to 2, the notable intervals 1 to 3 and the notable intervals 1 to 4 are the play scenes, the scene information of the notable intervals 1 to 2 and the notable intervals 1 to 3, which is included in the notable intervals 1 to 4, is not output.

If a part of the play scene indicated by the scene information is included in the play scene indicated by other scene information, the scene information having a greater level of importance (a greater play scene level) is output. That is, in the example of FIG. 6, if it is determined that the notable intervals 1 to 3 and the notable intervals 2 to 4 are the play scene, the candidate intervals 2 to 3 are included in either of the play scenes. At this time, the degrees of importance of the scene information of the play scenes are compared and, if it is determined that the degree of importance of the notable intervals 1 to 3 is greater, the scene information of the notable intervals 2 to 4 is not output.

By the above process, the notable interval in which the stop intervals are set as the start point and the end point is extracted, the play scene level according to the feature information of the interval is computed with respect to the extracted notable interval, and the notable interval in which the computed play scene level is high is determined as the play scene of the golf. The scene information indicating the notable interval which is determined as the play scene is output to the recording medium, the reproduction device, or the like. Accordingly, a user may simply skip the play scene to go to the next play scene based on the start time of the scene information when viewing a recorded golf program so as to more suitably reproduce the play scene of the golf in a digest.

Although, in the above description, the user skips and reproduces the play scene based on the start time of the scene information, in the reproduction device to which the scene information is output (supplied), the play scene may be automatically searched for based on the start time of the scene information.

### Functional Configuration Example of Reproduction Device

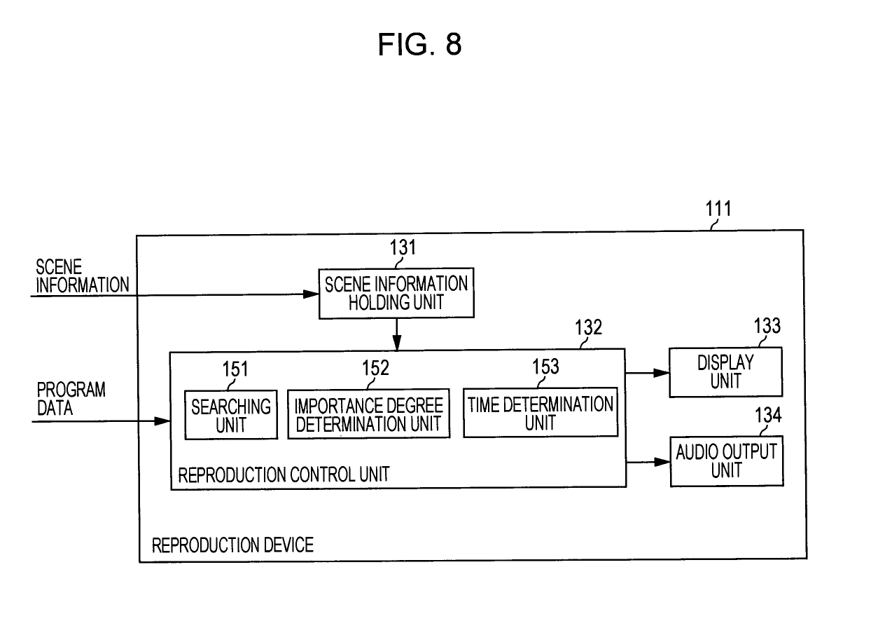

Here, the functional configuration example of the reproduction device for automatically searching for and reproducing the play scene of the golf program based on the scene information will be described with reference to FIG. 8.

The reproduction device 111 of FIG. 8 includes a scene information holding unit 131, a reproduction control unit 132, a display unit 133 and an audio output unit 134.

The scene information holding unit 131 stores (holds) the scene information supplied through a recording medium (not shown) or directly supplied from the play scene detection device 11 of FIG. 1. The scene information held in the scene information holding unit 131 is read to the reproduction control unit 132 as necessary.

The reproduction control unit 132 controls the reproduction of only the play scene indicated by the scene information held in the scene information holding unit 131 of the golf program based on the input golf program.

The reproduction control unit 132 includes a searching unit 151, an importance degree determination unit 152 and a time determination unit 153. The searching unit 151 searches for the play scene of the golf program based on the start time of the scene information held in the scene information holding unit 131. The importance degree determination unit 152 determines whether or not the play scene is reproduced based on the degree of importance (play scene level) of the scene information held in the scene information holding unit 131. The time determination unit 153 reproduces the play scene during a time indicated by the time length of the scene information held in the scene information holding unit 131.

The display unit 133 displays the golf program based on image data of the golf program (program data), the reproduction of which is controlled by the reproduction control unit 132.

The audio output unit 134 outputs audio included in the golf program based on audio data of the golf program (program data), the reproduction of which is controlled by the reproduction control unit 132.

### Play Scene Reproduction Process

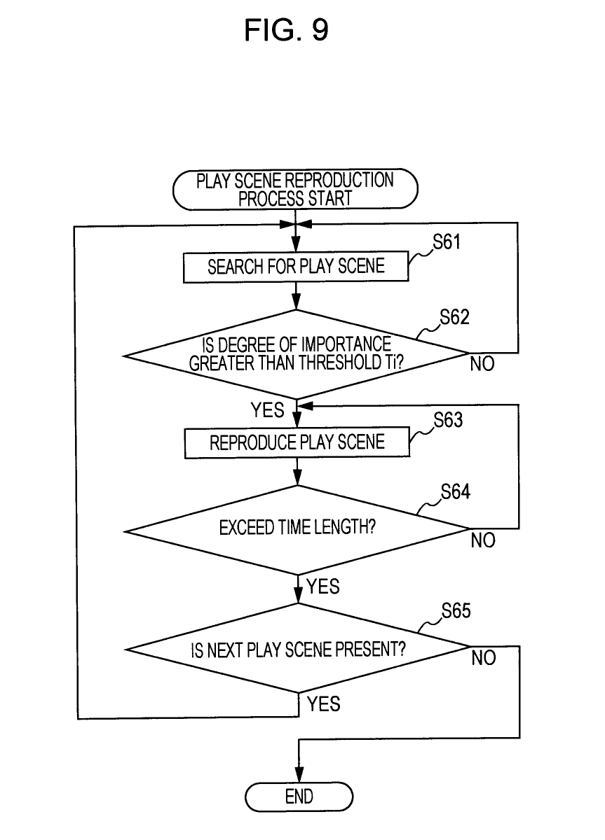

Next, the play scene reproduction process of the reproduction device 111 of FIG. 8 will be described with reference to the flowchart of FIG. 9. The scene information held in the scene information holding unit 131 is the scene information of the golf program input to the reproduction device 111.

In step S61, the searching unit 151 searches for the play scene of the input golf program based on the start time of the scene information held in the scene information holding unit 131.

In step S62, the importance degree determination unit 152 determines whether or not the degree of importance of the searched play scene is greater than a predetermined threshold Ti based on the degree of importance of the scene information held in the scene information holding unit 131.

In step s62, if it is determined that the degree of importance of the searched play scene is not greater than the threshold Ti, the process returns to step S61 and the next play scene is searched for.

Accordingly, a scene having a low degree of importance, that is, a scene in which the possibility of a play scene is low, may not be reproduced.

In contrast, in step S62, if it is determined that the degree of importance of the searched play scene is greater than the threshold Ti, the process proceeds to step S63 and the time determination unit 153 controls the reproduction of the play scene. Thus, the play scene is displayed on the display unit 133 and the audio included in the play scene is output by the audio output unit 134.

In step S64, the time determination unit 153 determines whether or not the reproduction time of the play scene exceeds the time length of the scene information based on the time length of the scene information held in the scene information holding unit 131.

If it is determined that the reproduction time of the play scene does not exceed the time length of the scene information in step S64, the process returns to step S63 and the processes of steps S62 and S63 are repeated until the reproduction time of the play scene exceeds the time length of the scene information.

If the reproduction time of the play scene exceeds the time length of the scene information in step S64, the process proceeds to step S65.

In step S65, the searching unit 151 determines whether or not the next play scene is present based on the start time of the scene information held in the scene information holding unit 131. Specifically, the searching unit 151 determines whether or not the scene information having a start time later than the start time of the currently reproduced play scene is present in the scene information holding unit 131.

In step S65, if it is determined that the next play scene is present, the process returns to step S61 and the processes of steps S61 to S65 are repeated.

In step S65, if it is determined that the next play scene is not present, since the next play scene is not present in the input golf program, the process finishes.

According to the above process, in the golf program, the play scene is searched for based on the scene information indicated by the play scene and the play scene is reproduced according to the degree of importance of the searched play scene. As a result, only the play scene of the golf program is reproduced as a highlight scene. Since only the play scene having a high degree of importance is reproduced, it is possible to avoid the reproduction of a scene having the possibility that it is not the play scene and more suitably reproduce the play scene of the golf in a digest.

Although, in the above description, the play scene detection device 11 for extracting the play scene and the reproduction device 111 for reproducing the play scene are separately configured, the play scene detection device 11 and the reproduction device 111 may be integrally configured. In the description below, an example in which the play scene detection device 11 and the reproduction device 111 are integrally configured will be described.

### 2. Second Embodiment

### Functional Configuration Example of Recording/Reproduction Device

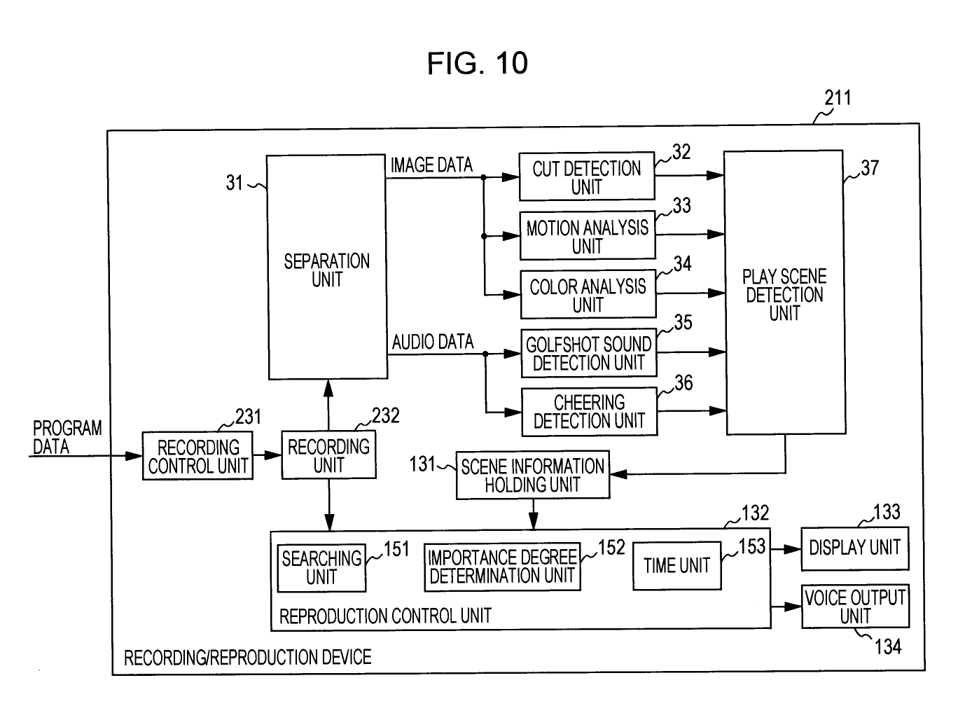

FIG. 10 shows the functional configuration example of the recording/reproduction device in which the play scene detection device 11 of FIG. 1 and the reproduction device 111 of FIG. 8 are integrally configured.

In the recording/reproduction device 211 of FIG. 10, the configurations having the same functions as those of the play scene detection device 11 of FIG. 1 and the reproduction device 111 of FIG. 8 are denoted by the same names and the same reference numerals and the description thereof will be appropriately omitted.

That is, in the case where the play scene detection device 11 of FIG. 1 and the reproduction device 111 of FIG. 8 are integrally viewed, the recording/reproduction device 211 of FIG. 10 is different from the play scene detection device 11 of FIG. 1 and the reproduction device 111 of FIG. 8 in that a recording control unit 231 and a recording unit 232 are newly provided.

In FIG. 10, the play scene extraction unit 37 supplies the scene information obtained by executing the play scene extraction process to the scene information holding unit 131.

The recording control unit 231 controls the recording of the golf program (program data) input to the recording/reproduction device 211 in the recording unit 232.

The recording unit 232 records the golf program based on the control of the recording control unit 231. The recorded golf program is read to the separation unit 31 or the reproduction control unit 132 based on the information according to the operation content of the user from an operation unit (not shown).

Even in the recording/reproduction device 211 of FIG. 10, the play scene detection device 11 of FIG. 1 and the reproduction device 111 of FIG. 8 have the same effects.

That is, the play scene extraction process by the recording/reproduction device 211 of FIG. 10 is fundamentally the same as the process of the play scene detection unit 37 (FIG. 4) of the play scene detection device 11 of FIG. 1, which is described with reference to the flowchart of FIG. 5, and thus the description thereof will be omitted.

The play scene reproduction process by the recording/reproduction device 211 of FIG. 10 is fundamentally equal to the process of the reproduction device 111 of FIG. 8, which is described with reference to the flowchart of FIG. 9, and thus the description thereof will be omitted.

The scenes broadcasted as the golf program include the scene of the putting on the green in addition to the scene of the shot of the teeing ground or the fairway.

According to the above-described play scene extraction process, it is possible to extract the scene of the shot from the teeing ground or the fairway as the play scene. However, in the scene of the putting, since the shot sound is not substantially present and the motion in the image is small, the scene of the putting may not be accurately extracted as the play scene by the above-described play scene extraction process.

In general, the scene of the putting may include the following features.

The motion amount of the image is not substantially present.

Most of the color of the image is green.

Cheers up go along with applause when the ball enters the hole.

Therefore, the color analysis unit 34 obtains a greenness level as color information and the play scene level computation unit 54 computes the play scene level using the motion information, the color information and the cheering information as the feature information, such that the scene of the putting may be extracted as the play scene.

The above-described series of processes may be executed by hardware or software. If the series of processes are executed by software, a program configuring the software is installed in a computer assembled by dedicated hardware, for example, a general-purpose personal computer capable of executing various functions by installing various programs, or the like from a program recording medium.

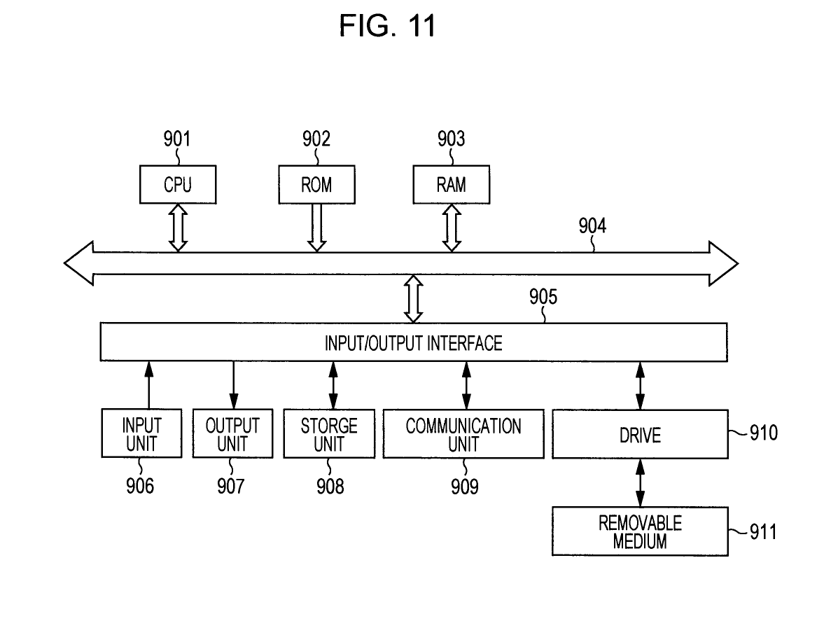

FIG. 11 is a block diagram showing a configuration example of hardware of a computer for executing the above-described series of processes by a program.

In the computer, a Central Processing Unit (CPU) 901, a Read Only Memory (ROM) 902 and a Random Access Memory (RAM) 903 are connected to each other by a bus 904.

An input/output interface 905 is connected to the bus 904. An input unit 906 including a keyboard, a mouse, a microphone, or the like, an output unit 907 including a display, a speaker, or the like, a storage unit 908 including a hard disk, a non-volatile memory or the like, a communication unit 909 including a network interface or the like, and a drive 910 for driving a removable medium 911 such as a magnetic disk, an optical disc, a magneto-optical disc, a semiconductor memory or the like are connected to the input/output interface 905.

In the computer having the above configuration, the CPU 901 loads and executes, for example, the program stored in the storage unit 908 to the RAM 903 through the input/output interface 905 and the bus 904 so as to perform the above-described series of processes.

The program executed by the computer (CPU 901) is recorded in the removable medium 911 which is a package media including a magnetic disk (including a flexible disk), an optical disc (a Compact Disc-Read Only Memory (CD-ROM), a Digital Versatile Disc (DVD), or the like), a magneto-optical disc, a semiconductor memory or the like or is provided through a wired or wireless transfer medium such as a local area network, the Internet, or a digital satellite broadcast.

The program may be installed in the storage unit 908 through the input/output interface 905 by mounting the removable medium 911 in the drive 910. The program may be received using the communication unit 909 through the wired or wireless transfer medium and installed in the storage unit 908. Alternatively, the program may be installed in the ROM 902 or the storage unit 908 in advance.

The program executed by the computer may be a program which is processed in time series in the order described in the present specification or a program which is processed in parallel or at a necessary timing such as when calling is performed.

The embodiments of the present invention are not limited to the above-described embodiments and may be variously modified without departing from the scope of the present invention.

The present application contains subject matter related to that disclosed in Japanese Priority Patent Application JP 2010-100927 filed in the Japan Patent Office on Apr. 26, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device for analyzing motion and color of an image of a program and detecting a shot sound and cheering of golf from sound of the program, comprising:
an extraction means for extracting a notable interval which is a notable time interval of the program based on the motion of the image;
a computation means for computing a play scene level indicating a degree to which the notable interval is a play scene of the golf based on the motion, color and shot sound of the notable interval extracted by the extraction means; and
a determination means for determining whether or not the notable interval is a play scene of the golf based on the play scene level computed by the computation means.

2. The information processing device according to claim 1, wherein the extraction means extracts the notable interval using a stop interval in which a motion amount of the image is less than a predetermined amount in the program as a start point and an end point of the notable interval.

3. The information processing device according to claim 2, wherein the computation means computes the play scene level of the notable interval based on the shot sound of the start point of the notable interval.

4. The information processing device according to claim 2, wherein the computation means computes the play scene level of the notable interval based on a maximum value of the motion of the notable interval.

5. The information processing device according to claim 2, wherein the computation means computes the play scene level of the notable interval based on a blueness level and a whiteness level of the color detected in the notable interval.

6. The information processing device according to claim 2, wherein the computation means computes the play scene level of the notable interval based on a change of a vertical direction of the motion of the notable interval.

7. The information processing device according to claim 2, wherein the computation means computes the play scene level of the notable interval based on small motion of the start point and the end point of the notable interval.

8. The information processing device according to claim 1, wherein the determination means weights the cheering detected in the notable interval to the play scene level of the notable interval computed by the computation means and determines whether or not the notable interval is the play scene of the golf.

9. The information processing device according to claim 1, further comprising a reproduction control means for controlling reproduction of only the play scene of the program based on scene information indicating the notable interval regarded as the play scene as the determination result of the determination means.

10. An information processing method of an information processing device which analyzes motion and color of an image of a program and detects a shot sound and cheering of golf from sound of the program and includes an extraction means for extracting a notable interval which is a notable time interval of the program based on the motion of the image, a computation means for computing a play scene level indicating a degree to which the notable interval is a play scene of the golf based on the motion, color and shot sound of the notable interval extracted by the extraction means, and a determination means for determining whether or not the notable interval is a play scene of the golf based on the play scene level computed by the computation means, the information processing method comprising the steps of:
extracting the notable interval which is the notable time interval of the program based on the motion of the image, by the extraction means
computing the play scene level indicating a degree to which the notable interval is the play scene of the golf based on the motion, color and shot sound of the notable interval extracted by the step of extracting, by the computation means; and
determining whether or not the notable interval is the play scene of the golf based on the play scene level computed by the step of computing, by the determination means.

11. A program for executing, on a computer, a process of analyzing motion and color of an image of a program and detecting a shot sound and cheering of golf from sound of the program, the process comprising the steps of:
extracting a notable interval which is a notable time interval of the program based on the motion of the image;
computing a play scene level indicating a degree to which the notable interval is a play scene of the golf based on the motion, color and shot sound of the notable interval extracted by the extracting step; and
determining whether or not the notable interval is a play scene of the golf based on the play scene level computed by the computing step.

12. An information processing device for analyzing motion and color of an image of a program and detecting a shot sound and cheering of golf, comprising:
an extraction unit that extracts a notable interval which is a notable time interval of the program based on the motion of the image;
a computation unit that computes a play scene level indicating a degree to which the notable interval is a play scene of the golf based on the motion, color and shot sound of the notable interval extracted by the extraction unit; and
a determination unit that determines whether or not the notable interval is a play scene of the golf based on the play scene level computed by the computation unit.
